(19) United States
(12) Patent Application Publication
(10) Pub. No.: US 2023/0168441 A1
(43) Pub. Date: Jun. 1, 2023

(54) UNJACKETED FIBER OPTIC CABLE ASSEMBLY, AND CABLE ASSEMBLY INCLUDING CONNECTOR WITH TRAVEL LIMITED FERRULE

(71) Applicant: CORNING RESEARCH & DEVELOPMENT CORPORATION, Corning, NY (US)

(72) Inventors: Gregory Blake Bohler, Lenoir, NC (US); Jeffrey Dean Danley, Hickory, NC (US); Robert Bruce Elkins, II, Hickory, NC (US); Eric Raymond Logan, Huntersville, NC (US); Darrin Max Miller, Hickory, NC (US)

(21) Appl. No.: 17/988,931

(22) Filed: Nov. 17, 2022

Related U.S. Application Data
(60) Provisional application No. 63/284,104, filed on Nov. 30, 2021.

(51) Int. Cl. G02B 6/38

(52) U.S. Cl. CPC G02B 6/3882; G02B 6/3825

(57) ABSTRACT

A fiber optic cable assembly comprises first and second cable legs each including a tight buffer surrounding coated optical fibers, and a reduced thickness buffer connecting region, with cable leg being devoid of any surrounding jacket and any tensile strength member. A fiber optic cable assembly devoid of a tensile strength member mechanically coupled to a connector comprises a travel limiting feature that serves to limit travel of the ferrule and inhibit ferrule decoupling when tension is applied to a fiber optic cable.

### PRIORITY APPLICATION

This application claims the benefit of priority of U.S. Provisional Application No. 63/284,104, filed on Nov. 30, 2021, the content of which is relied upon and incorporated herein by reference in its entirety.

### BACKGROUND

This disclosure relates generally to optical fibers, and more particularly to fiber optic cables and connectors not relying on strength members for accommodating tensile loads.

Optical fibers are useful in a wide variety of applications, including the telecommunications industry for voice, video, and data transmissions. Various types of fiber optic cables exist, with such cables frequently containing one or more optical fibers and tensile strength members (e.g., aramid yarn) within a buffer or jacket. The type, contents, and materials of fiber optic cables can vary depending on the end use application and intended use environment.

In a telecommunications system that uses optical fibers, there are typically many locations where fiber optic cables that carry the optical fibers connect to equipment or other fiber optic cables. To conveniently provide these connections, fiber optic connectors (“connectors”) are often provided on the ends of fiber optic cables. Many different types of fiber optic connectors exist, and may be used for mating with equipment or other connectors. Tensile strength members of fiber optic cables may be mechanically coupled with portions of fiber optic connectors to prevent optical fibers from bearing tensile loads applied to fiber optic cables.

Hyperscale data centers are proliferating in various locations around the world. These data centers utilize massive amounts of optical fibers and interconnects between fiber optic equipment, including jumper cables. Customers seeking to develop data centers are sensitive to considerations such as optical fiber density, cost, configurability, and scalability.

The art continues to seek improved fiber optic cable assemblies that address limitations associated with conventional implementations.

### SUMMARY

Aspects of the present disclosure provide fiber optic cable assemblies that do not rely on tensile strength members mechanically coupled with connectors. A first fiber optic cable assembly includes first and second cable legs each including a tight buffer surrounding coated optical fibers, and a reduced thickness buffer connecting region connecting the tight buffers of the two cable legs, wherein each cable leg is devoid of any surrounding jacket, and the fiber optic cable assembly is devoid of any tensile strength member. The buffer connecting region may be locally torn by manually pulling apart the cable legs, to function as a zip cord. Further fiber optic cable assemblies are devoid of mechanical coupling between any tensile strength member optionally present in a fiber optic cable, such that tensile loads may be transmitted from an optical fiber to a fiber optic connector ferrule bonded thereto, wherein a travel limiting feature is provided to limit travel of the ferrule and reduce the likelihood of decoupling of the ferrule from a mating ferrule connected thereto.

In an exemplary aspect, the disclosure relates to a fiber optic cable assembly comprising a first cable leg, a second cable leg, and a buffer connecting region. The first cable leg comprises a first optical fiber core, a first cladding surrounding the first optical fiber core, a first coating surrounding the first cladding, and a first tight buffer surrounding and in contact with the first coating. The second cable leg comprises a second optical fiber core, a second cladding surrounding the second optical fiber core, a second coating surrounding the second cladding, and a second tight buffer surrounding and in contact with the second coating. The buffer connecting region connects the first tight buffer and the second tight buffer, wherein the buffer connecting region comprises a maximum thickness that is less than a maximum outer thickness dimension of the first tight buffer and that is less than a maximum outer thickness dimension of the second tight buffer. Each of the first cable leg and the second cable leg is devoid of a surrounding jacket, and is devoid of any tensile strength member.

In certain embodiments, the first tight buffer, the second buffer, and the buffer connecting region comprise extruded polymeric material.

In certain embodiments, the buffer connecting region comprises a thermally welded and/or solvent welded interface between the first tight buffer and the second tight buffer.

In certain embodiments, the buffer connecting region is configured to be locally torn by manually pulling apart a portion of the first cable leg and a portion of the second cable leg.

In certain embodiments, the first tight buffer comprises an outer diameter of no greater than 1.6 mm, and the second tight buffer comprises an outer diameter of no greater than 1.6 mm.

In certain embodiments, the first tight buffer comprises an outer diameter of no greater than 1 mm, and the second tight buffer comprises an outer diameter of no greater than 1 mm.

In certain embodiments, each of the first cladding and the second cladding comprises a titanium dioxide coating.

In certain embodiments, the fiber optic cable assembly further comprises a first ferrule bonded to the first cladding with heat curable epoxy, and a second ferrule bonded to the second cladding with heat curable epoxy.

In certain embodiments, the fiber optic cable assembly further comprises at least one connector terminating a proximal end of the first cable leg and terminating a proximal end of the second cable leg.

In certain embodiments, the at least one connector comprises a first connector terminating the proximal end of the first cable leg and a second connector terminating the proximal end of the second cable leg.

In certain embodiments, the maximum thickness of the buffer connecting region is less than 50% of the maximum outer thickness dimension of the first buffer, and is less than 50% of the maximum outer thickness dimension of the second buffer.

In another aspect, the disclosure relates to a fiber optic cable assembly comprising a first optical fiber emanating from a first fiber optic cable, and a fiber optic connector that comprises a first ferrule, a first ferrule holder, a first housing, and a travel limiting feature. The first ferrule terminates and is bonded to a portion of the first optical fiber. The first ferrule holder arranged to support the first ferrule in the first housing, wherein the first ferrule holder is spring-biased and is and configured to press the first ferrule in a longitudinally outward direction relative to a proximal end of the first fiber optic connector. The travel limiting feature is configured to limit travel of the first ferrule in a longitudinally inward direction, opposing the longitudinally outward direction, to a distance less than a decoupling distance due to travel of the first ferrule when the first ferrule is arranged in mating contact with a second ferrule of a second fiber optic connector. The first fiber optic connector is devoid of mechanical coupling with any tensile strength member optionally present in the first fiber optic cable.

In certain embodiments, the first fiber optic connector comprises a spring configured to bias the first ferrule holder; the spring comprises a maximum spring length and a minimum spring length within the housing, with the minimum spring length corresponding to a fully compressed state of the spring; and the travel limiting feature is provided by configuring the spring such that a difference between the maximum spring length and the minimum spring length that is less than the decoupling travel distance of the first ferrule.

In certain embodiments, the housing comprises at least one radially inward protruding feature; the ferrule holder comprises at least one peripheral recess configured to receive the at least one radially inward protruding feature, the at least one peripheral recess is bounded by at least one travel stop configured to contact the at least one radially inward protruding feature; and the travel limiting feature is provided by cooperation between the radially inward protruding feature and the at least one peripheral recess, whereby contact between the at least one radially inward protruding feature and the at least one travel stop is configured to limit travel of the ferrule in a longitudinally inward direction that opposes the longitudinally outward direction.

In certain embodiments, the first ferrule comprises a substantially cylindrical body defining a first bore that receives a portion of the first optical fiber.

In certain embodiments, the first fiber optic cable comprises a first tight buffer surrounding a coating, a cladding, and a core of the first optical fiber at a position outside the first ferrule, and the first fiber optic cable is devoid of any tensile strength member.

In certain embodiments, the cladding comprises a titanium dioxide coating.

In certain embodiments, the cladding is bonded to the ferrule with heat curable epoxy.

In another aspect, the disclosure relates to a fiber optic cable assembly comprising an optical fiber emanating from a fiber optic cable, and a fiber optic connector that comprises a ferrule, a ferrule holder, and a housing. The ferrule terminates and is bonded to a portion of the optical fiber. The ferrule holder is arranged to support the ferrule in the housing, the ferrule holder being spring-biased and configured to press the ferrule in a longitudinally outward direction relative to a proximal end of the fiber optic connector. The housing comprises at least one radially inward protruding feature. The ferrule holder comprises at least one recess configured to receive the at least one radially inward protruding feature, and the at least one recess is bounded by at least one travel stop configured to contact the at least one radially inward protruding feature to limit travel of the ferrule in a longitudinally inward direction that opposes the longitudinally outward direction. The first fiber optic connector is devoid of mechanical coupling with any tensile strength member optionally present in the first fiber optic cable.

In certain embodiments, the ferrule comprises a substantially cylindrical body defining a bore that receives a portion of the optical fiber.

In certain embodiments, the fiber optic cable comprises a tight buffer surrounding a coating, a cladding, and a core of the optical fiber at a position outside the ferrule, and the fiber optic cable is devoid of any tensile strength member.

In certain embodiments, the cladding comprises a titanium dioxide coating.

In certain embodiments, the cladding is bonded to the ferrule with heat curable epoxy.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional view of a conventional coated optical fiber.

FIG. 2 is a cross-sectional view of a conventional fiber optic cable including a coated optical fiber surrounded by tensile strength members and a buffer or jacket.

FIG. 3 is a cross-sectional view of a conventional, zip-cord type fiber optic cable comprising first and second legs with optical fibers each surrounded by tensile strength members and a buffer or jacket, with a reduced thickness jacket coupling region.

FIG. 4A is a cross-sectional view of a conventional fiber optic cable in a partially stripped condition prior to insertion into a ferrule retained by a ferrule holder.

FIG. 4B is a cross-sectional view of the fiber optic cable of FIG. 4A terminated by a conventional fiber optic connector incorporating the ferrule and ferule holder of FIG. 4A.

FIG. 5 is a cross-sectional view of a fiber optic cable including first and second cable legs connected by a buffer connecting region and being devoid of a surrounding jacket and strength members, the fiber optic cable being useable in a fiber optic cable assembly according to one or more embodiment.

FIG. 6 is a perspective view of an extruder engaged in production of the fiber optic cable of FIG. 5.

FIG. 7 is a cross-sectional view of another fiber optic cable including first and second cable legs connected by a buffer connecting region and being devoid of a surrounding jacket and strength members, the fiber optic cable being useable in a fiber optic cable assembly according to one or more embodiments.

FIG. 8 is a top plan view of a fiber optic cable assembly including the fiber optic cable of FIG. 5 with end portions thereof terminated by fiber optic connectors.

FIG. 9 is a side cross-sectional view of a fiber optic connector configured for terminating a fiber optic cable in a ferrule supported by a spring-biased ferrule holder and useable in a fiber optic cable assembly according to one or more embodiments, showing the application of tension to the fiber optic cable and contact force on a tip of the ferrule.

FIG. 10 is a side-cross sectional view of two fiber optic connectors according to FIG. 9 in a mating relationship with contact between proximal ends of ferrules thereof.

FIG. 11 is a side cross-sectional view of portions of the two fiber optic connectors of FIG. 10 received within an adapter, with contact between proximal ends of ferrules of the fiber optic connectors.

FIG. 12A is a side cross-sectional view of a fiber optic connector configured for terminating a fiber optic cable in a ferrule supported by a spring-biased ferrule holder disposed within a housing, including a radially inward protruding feature of the housing received within a recess of the ferrule holder bounded by a travel stop to limit travel of the ferrule in a longitudinally inward direction.

FIG. 12B is a cross-sectional view of a portion of the fiber optic connector of FIG. 12A including the ferrule holder and a portion of the ferrule.

### DETAILED DESCRIPTION

Various embodiments will be further clarified by examples in the description below. In general, the description relates to fiber optic cable assemblies that do not rely on tensile strength members mechanically coupled with connectors. A first fiber optic cable assembly includes first and second cable legs each including a tight buffer surrounding coated optical fibers, and a reduced thickness buffer connecting region connecting the tight buffers of the two cable legs, wherein each cable leg is devoid of any surrounding jacket, and the fiber optic cable assembly is devoid of any tensile strength member. The buffer connecting region may be locally torn by manually pulling apart the cable legs, to function as a zip cord. Further fiber optic cable assemblies are devoid of mechanical coupling between any tensile strength member optionally present in a fiber optic cable, such that tensile loads may be transmitted from an optical fiber to a fiber optic connector ferrule bonded thereto, wherein a travel limiting feature is provided to limit travel of the ferrule and reduce the likelihood of decoupling of the ferrule from a mating ferrule connected thereto.

Before discussing fiber optic cable assemblies according to the present disclosure, conventional optical fibers, fiber optic cables, and fiber optic connectors will be introduced.

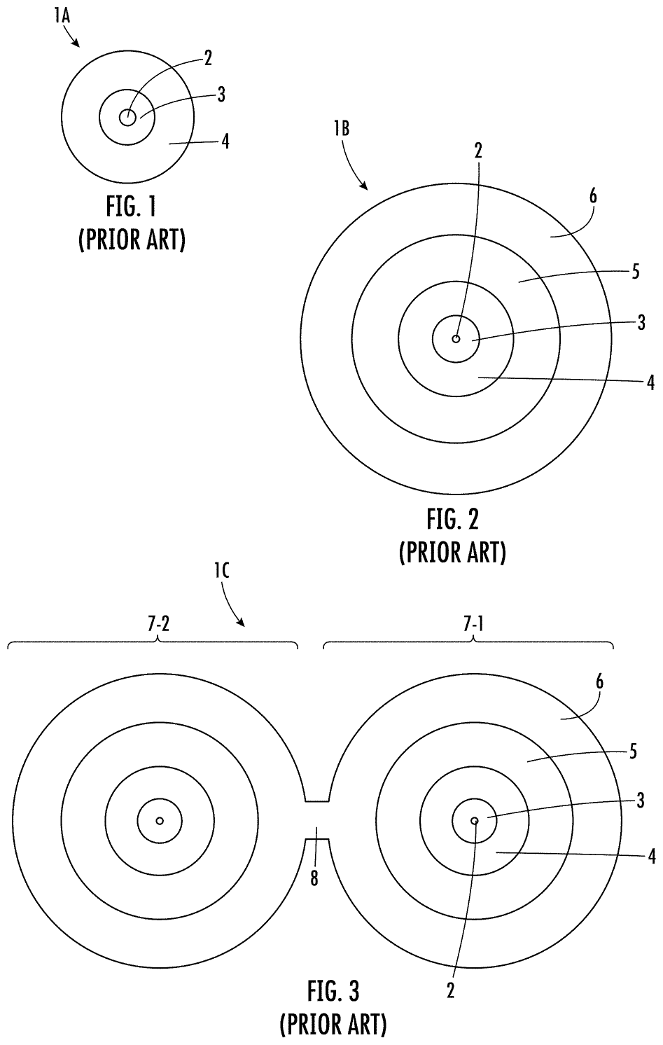

FIG. 1 is a cross-sectional view of a conventional optical fiber 1A having a core 2 surrounded by cladding 3 that is surrounded by a polymeric (e.g., acrylate) coating 4, each arranged in an elongated cylindrical shape. The cladding 3 may be formed of pure silica, and the core 2 may be formed of doped silica, although dopants may be present in each of these layers, and materials other than silica may be used. The coating 4 may function to protect the core 2 and cladding 3 from external abrasion, microbending losses, and stress corrosion or fatigue. For a single-mode optical fiber, a diameter of the core 2 is typically in a range of 8-10 μm, the cladding 3 has a diameter of 125 μm, and the coating 4 has a diameter of 250 μm. For a multi-mode optical fiber, a diameter of the core 2 is typically in a range of 50-100 μm, the cladding 3 has a diameter of 125 μm, and the coating 4 has a diameter of 250 μm. Optionally, the optical fiber 1A may be incorporated in a fiber optic cable having a 900 μm diameter tight buffer (not shown) surrounding and in contact with the coating 4.

FIG. 2 is a cross-sectional view of a conventional fiber optic cable 1B having a core 2 surrounded by cladding 3 that is surrounded by a polymeric coating 4, with tensile strength members 5 (e.g., aramid yarn) surrounding the coating 4, and a buffer or jacket 6 surrounding the tensile strength members 5. The tensile strength members 5 provide tensile strength to a finished cable assembly, and are mechanically coupled (e.g., crimped) to a connector body so that any pull stress applied to a cable after it is connectorized will be borne by the tensile strength members 5 instead of the core 2 and cladding 3.

FIG. 3 is a cross-sectional view of a conventional, zip-cord type fiber optic cable comprising first and second legs 7-1, 7-2 each having a core 2 surrounded by cladding 3 that is surrounded by a polymeric coating 4, with tensile strength members 5 (e.g., aramid yarn) surrounding the coating 4, and a buffer or jacket 6 surrounding the tensile strength members 5. A reduced thickness jacket coupling region 8 is provided to couple the jackets 6 of the first and second legs 7-1, 7-2. The jacket coupling region 8 may be configured to be locally torn when a user manually pulls apart the legs 7-1, 7-2, so that ends of the legs 7-1, 7-2 may be separately manipulated thereafter.

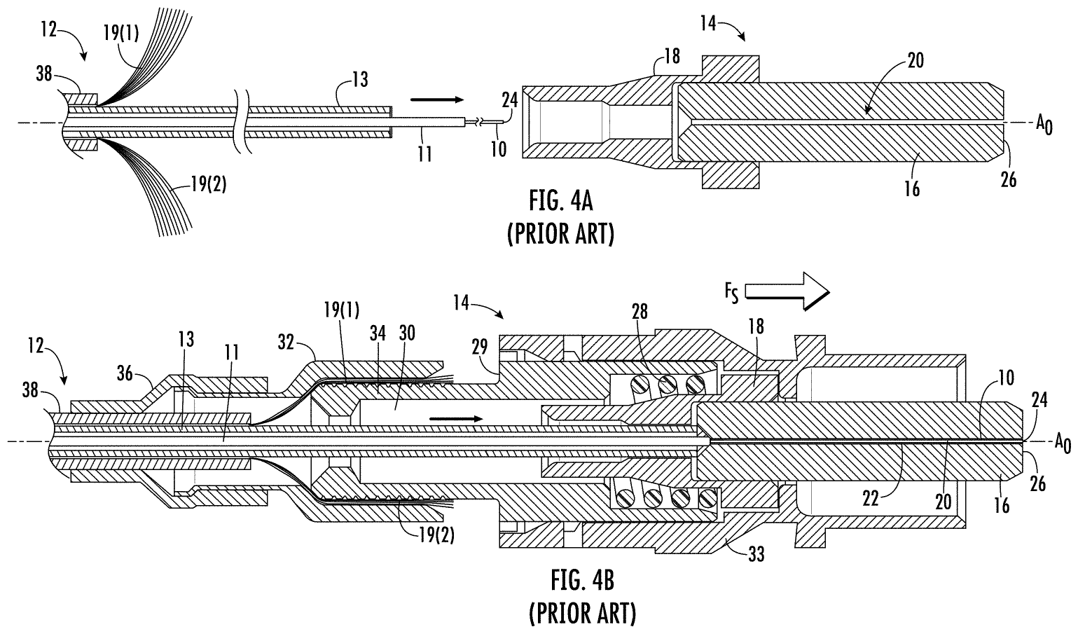

FIG. 4A is a cross-sectional view of a conventional fiber optic cable 12 in a partially stripped condition, prior to insertion into a ferrule 16 retained by a ferrule holder 18. The fiber optic cable 12 includes an optical fiber 10 (i.e., with a core and cladding) surrounded by a coating 11 and a buffer 13, with strength members 19(1), 19(2) arranged between the buffer 13 and the outer jacket 38. The strength members 19(1), 19(2) may comprise aramid yarn or the like, and are used to secure the fiber optic cable 12 to a fiber optic connector (14 in FIG. 4B) to bear any tensile loads applied to the fiber optic cable 12 without causing such loads to be applied to the optical fiber 10. The ferrule 16 includes a ferrule bore 20 into which the optical fiber 10 is inserted.

FIG. 4B is a cross-sectional view of the fiber optic cable 12 of FIG. 4A terminated by a conventional fiber optic connector 14 incorporating the ferrule 16 and ferule holder 18, which are received within a housing assembly 29 and an outer body 33. The optical fiber 10 may be bonded within the ferrule bore 20 using a bonding agent 22, to hold an end portion 24 of the optical fiber 10 at an end face 26 of the ferrule 16, where the end portion 24 of the optical fiber 10 may establish an optical connection with a complementary end portion (not shown) of another optical fiber. To promote good contact between the end face 26 of the ferrule 16 and a complementary end portion of another optical fiber (e.g. contained in another ferrule (not shown)), the ferrule 16 may be spring loaded with a spring 28 providing a spring force Fs to bias the ferrule 16 to a forward position within the housing assembly 29. The housing assembly 29 and the outer body 33 may be stationary when an optical connection is established between the end portion 24 of the optical fiber 10 and the complementary end portion (not shown). The housing assembly 29 includes a passage 30 accommodating and permitting slight movement of the buffer 13 while the ferrule 16 may move in a longitudinal direction (along longitudinal axis A₀) as the fiber optic connector 14 may be optically connected and disconnected during use. The fiber optic cable 12 may be secured to the housing assembly 29 by disposing the strength members 19(1), 19(2) between a crimp band 32 and a portion 34 of the housing assembly 29, so that the strength members 19(1), 19(2) may bear any tensile loads applied to the fiber optic cable 12 without applying such loads to the optical fiber 10. Avoiding application of tensile load to an optical fiber 10 may avoid disengagement or loosening between the optical fiber 10 and the ferrule 16. A heat shrink member 36 may be provided to prevent contaminants from entering the fiber optic connector 14, but is not a structural member securing the fiber optic cable 12 longitudinally to the housing assembly 29 of the fiber optic connector 14.

Recent advances in stripping fiber coatings and in bonding optical fibers to ferrules have rendered it possible for optical fibers to bear greater tensile loads than previously considered feasible. For instance, advances in laser stripping of acrylate coatings from optical fibers enable near virgin strength of the optical fibers to be maintained, and utilization of two-part heat curable epoxy formulations for bonding optical fibers to ferrules have enhanced bonding strength. Given these developments, the inventors realized that novel fiber optic cable assemblies may not require tensile strength members mechanically coupled to connectors terminating ends of fiber optic cables, and associated jackets for retaining tensile strength members, for end use applications such as fiber optic jumper cables. This realization led to development of fiber optic cable assemblies according to embodiments of the present disclosure. Moreover, the addition of a titanium dioxide (or titania) coating over cladding of an optical fiber may result in improved mechanical properties including fatigue resistance. In certain embodiments, a titanium dioxide coating may be applied over cladding of an optical fiber by outside vapor deposition.

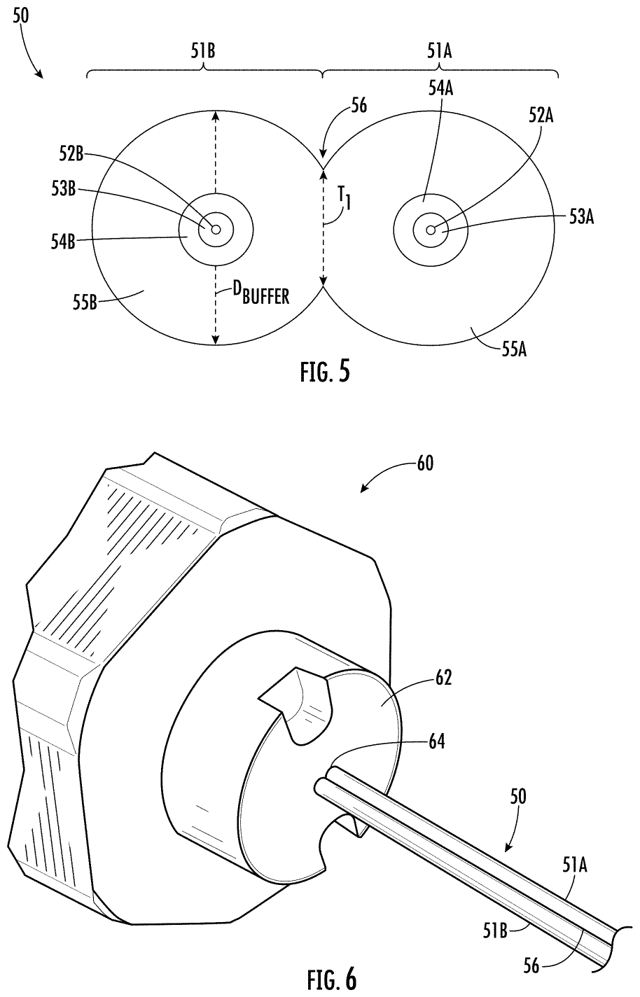

FIG. 5 is a cross-sectional view of a fiber optic cable 50 including first and second cable legs 51A, 51B, each including a fiber core 52A, 52B surrounded by cladding 53A, 53B and a coating 54A, 54B, further surrounded by a tight buffer 55A, 55B, with the tight buffers 55A, 55B of the respective cable legs 51A, 51B being connected by a buffer connecting region 56. The fiber optic cable 50 may be used as part of a fiber optic cable assembly according to one or more embodiments herein. The buffer connecting region 56 has a thickness T₁ that is less than a maximum outer thickness dimension D_{BUFFER} of each tight buffer 55A, 55B. In certain embodiments, T₁ is no greater than 75%, no greater than 60%, no greater than 50%, no greater than 40%, no greater than 30%, or no greater than 20%, of D_{BUFFER}. In certain embodiments, the buffer connecting region 56 is configured to be locally torn by manually pulling apart a portion of the first cable leg 51A and a portion of the second cable leg 51B.

In certain embodiments, the tight buffer 55A, 55B of each cable leg 51A, 51B is round or oval in shape. In certain embodiments, a buffer connecting region 56 has a non-zero width, such that a width of the fiber optic cable 50 is more than twice the maximum outer thickness dimension D_{BUFFER} of each tight buffer 55A, 55B. In certain embodiments, each tight buffer 55A, 55B comprises a generally round- or oval-shaped lobe that is truncated by an overlap of the respective lobes, with the buffer connecting region 56 has a zero or near-zero width, such that a width of the fiber optic cable 50 is less than twice the maximum outer thickness dimension D_{BUFFER} of each tight buffer 55A, 55B. In certain embodiments, each fiber core 52A, 52B is centered within (e.g., coincident with a centroid of) the corresponding cable leg 51A, 51B. In certain embodiments, each fiber core 52A, 52B is offset relative to (e.g., non-coincident with a centroid of) the corresponding cable leg 51A, 51B. In certain embodiments, each cable leg 51A, 51B has a maximum outer thickness dimension D_{BUFFER} of about 1.5 mm, of about 900 μm, of less than about 1.6 mm, of less than about 1.0 mm, or of less than about 900 μm.

In certain embodiments, the first tight buffer 55A, the second tight buffer 55B, and the buffer connecting region 56 are formed by a single extrusion process, and comprise a unitary extruded polymeric material. In certain embodiments the first and second cable legs 51A, 51B may be produced separately (e.g., by extrusion) and joined together thereafter, such as by a thermal welding and/or solvent welding process, with the buffer connecting region 56 comprising a thermally welded and/or solvent welded interface between the first tight buffer 55A and the second tight buffer 55B.

The fiber optic cable 50 provides various advantages over prior cables having strength members and outer jackets, including reduced size (e.g., cross-sectional area), increased flexibility, reduced cost, and easy field configurability (e.g., permitting a user in the field to configure the cable as two fiber duplex, two fiber simplex, or single fiber simplex.

FIG. 6 is a perspective view of an extruder 60 having an extrusion head 62 and an aperture 64, being used for producing the fiber optic cable 50 of FIG. 5. The aperture 64 may have a “figure-8” cross-sectional shape to simultaneously produce the first and second legs 51A, 51B with a reduced thickness buffer connecting region 56 therebetween.

FIG. 7 is a cross-sectional view of another fiber optic cable 70 including first and second cable legs 71A, 71B. Each leg 71A, 71B includes a fiber core 72A, 72B that is surrounded by cladding 73A, 73B and a coating 74A, 74B, and is further surrounded by a tight buffer 75A, 75B, with the tight buffers 75A, 75B of the respective cable legs 71A, 71B being connected by a buffer connecting region 76. The fiber optic cable 70 is useable in a fiber optic cable assembly according to one or more embodiments herein. The buffer connecting region 76 has a thickness T₂ that is less than a maximum outer thickness dimension D_{BUFFER} of each tight buffer 75A, 75B. In certain embodiments, T₂ is no greater than 75%, no greater than 60%, no greater than 50%, no greater than 40%, no greater than 30%, or no greater than 20%, of D_{BUFFER}. As shown, each fiber core 72A, 72B may be located off-center relative to the corresponding cable leg 71A, 71B, but in certain embodiments each fiber core 72A, 72B may be substantially centered within a corresponding buffer 75A, 75B of a cable leg 71A, 71B.

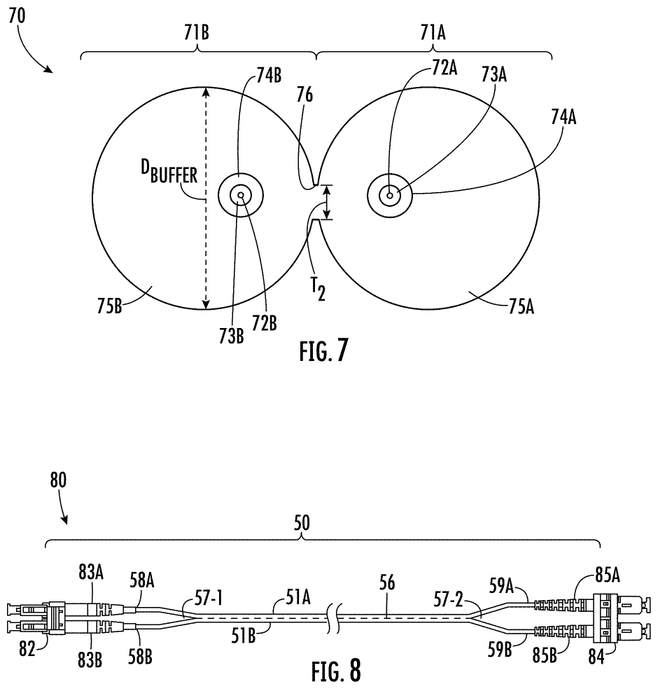

FIG. 8 is a top plan view of a fiber optic cable assembly 80 including the fiber optic cable 50 of FIG. 5, with first end portions 58A, 58B terminated by a first fiber optic connector 82, and with second end portions 59A, 59B terminated by a second fiber optic connector 84. A first separation 57-1 in the buffer connecting region 56 is provided between the cable legs 51A, 51B proximate to the first end portions 58A, 58B, and a second separation 57-2 in the buffer connecting region 56 is provided between the cable legs 51A, 51B proximate to the second end portions 59A, 59B, wherein the first and second separations 57-1, 57-2 may be formed by locally tearing the buffer connecting region 56 by manually pulling apart the cable legs 51A, 51B. As shown, the first fiber optic connector 82 is a duplex LC connector, and the second fiber optic connector 84 is a duplex SC connector, but any suitable types of connectors may be used, either in simplex form (embodying separate connectors for each cable leg 51A, 51B) or in duplex form (including one connector for both cable legs 51A, 51B). In certain embodiments, the fiber optic cable assembly 80 comprises a pre-connectorized jumper cable having a length of less than 10 m, less than 5 m, or less than 3 m.

The fiber optic cable assembly 80 may be produced in several steps. One step includes mechanically separating the first end portions 58A, 58B by locally tearing the buffer connecting region 56, and mechanically separating the second end portions 59A, 59B by locally tearing the buffer connecting region 56. Another step includes slipping connector boots onto the end portions 58A, 58B, 59A, 59B. Another step includes mechanically stripping the tight buffer (55A, 55B in FIG. 6) from each cable leg 51A, 51B to expose (e.g., 250 μm diameter) the acrylate coating (54A, 54B in FIG. 6). End portions 58A, 58B, 59A, 59B may separately be inserted into a carrier (not shown) and laser stripped in a laser stripping station (not shown) to expose the cladding (53A, 53B in FIG. 6) of each cable leg 51A, 51B. Ferrules of suitable connectors (e.g., LC connector 82 or SC connector 84) are pre-loaded with a bonding agent (such as multi-part epoxy curable by heat activation), positioned over stripped end portions 58A, 58B, 59A, 59B, and sequentially placed into a heating apparatus (not shown) to apply a heating profile for a sufficient time to activate the bonding agent. Optionally, a blast of cold air may be immediately applied to each ferrule to enhance adhesion strength. Thereafter, connector housing and/or boot portions may be slid into place, and end faces of connector ferrules may be subjected to polishing and testing steps. In certain embodiments, the multi-part epoxy may comprise MasterBond® EP-62 (Master Bond Inc., Hackensack, N.J., US) or Loctite® ECCOBOND F 123 (Henkel Corporation, Dusseldorf, Germany) epoxy formulations. Average adhesion strengths in excess of 34.6 N (7.8 lbf) have been observed for adhesion of 125 μm clad fibers to ferrules have been observed by the inventors.

The foregoing fiber optic cables 50, 70 devoid of tensile strength members may be utilized as part of fiber optic cable assemblies lacking strain relief or any mechanism that prevents cable tension from being applied to a ferrule. One implication of this situation is that any fiber optic cable tension transferred to an optical fiber therein and that exceeds a spring force within a connector having a spring-biased ferrule may potentially un-mate the ferrule from another ferrule mated therewith. To address this issue, fiber optic cable assemblies according to embodiments herein include a travel limiting feature configured to limit travel of the ferrule and reduce the likelihood of decoupling of a spring-biased ferrule from a mating ferrule connected thereto.

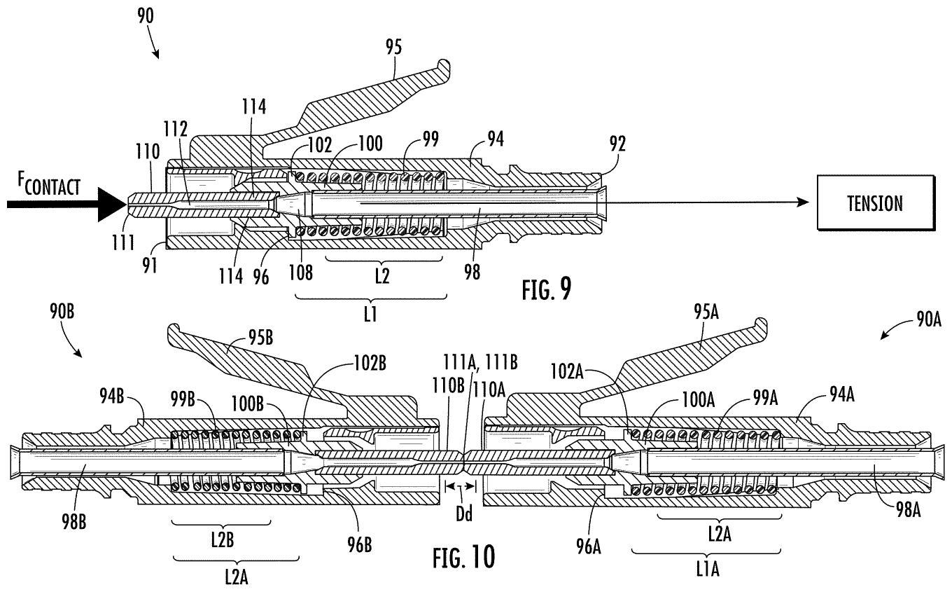

FIG. 9 is a side cross-sectional view of a fiber optic connector 90 configured for terminating a fiber optic cable in a ferrule 110 supported by a spring-biased ferrule holder 100 and useable in a fiber optic cable assembly according to one or more embodiments devoid of mechanical coupling between tensile strength members and a fiber optic connector. The fiber optic connector 90 includes a housing 94 (which may be unitary or composed of multiple parts) having a proximal end 91, a distal end 92, a depressible latch 95, and a cavity 98 bounded in part by a medial shoulder 96. The cavity 98 contains the ferrule holder 100, which is positioned between the ferrule 110 and a spring 99. The spring 99 is configured to provide a longitudinal spring force to press the ferrule 110 outward relative to the housing 94 to oppose a contact force (F_{CONTACT}) applied to a proximal end 111 of the ferrule 110 when mated with another ferrule (not shown). The ferrule holder 100 includes a proximal cavity 104 that retains the ferrule 110, a distal cavity 108 that can receive a coated or buffered portion of an optical fiber (e.g. buffer 13 in FIG. 4A), and includes a radially extending lip 102 that is configured to contact the medial shoulder 96 to limit travel of the ferrule holder 100 in a forward or longitudinally outward direction. The ferrule 110 has a substantially cylindrical body and includes a bore 112 configured to receive at least a portion of an optical fiber (e.g., 10 in FIG. 4A), whereby a tip of the optical fiber may be terminated flush with the proximal end 111 thereof, which protrudes forward from the proximal end 91 of the housing 94. The connector 90 lacks any crimp band or other feature to promote mechanical coupling with strength members of a fiber optic cable. When an optical fiber is received within the ferrule 110 and bonded thereto (e.g., by bonding cladding of the optical fiber to the ferrule 110 with heat curable epoxy), application of tension to the optical fiber extending rearward from the distal end 92 of the connector 90 is transferred to the ferrule 110 by virtue of bonding between the ferrule 110 and the optical fiber. This tensile force generally opposes the (biasing) spring force provided by the spring 99, and can compress the spring 99, permitting the ferrule holder 100 and the ferrule 110 to move toward the distal end 92 of the housing. This tensile force can cause the spring 99 to transition from a first (elongated) length L₁ to a second (compressed) length L₂. If the difference between the first length L₁ and the second length L₂ exceeds a decoupling travel distance of the ferrule 110 when the ferrule 110 is arranged in mating contact with a ferrule of another fiber optic connector (e.g., ferrule 110B in FIG. 10), then the ferrule 110 with an optical fiber therein may enter a decoupled state and optical signal transfer may be lost.

FIG. 10 is a side-cross sectional view of two fiber optic connectors 90A, 90B according to FIG. 9 in a mating relationship with contact between proximal ends of ferrules 110A, 110B of the connectors 90A, 90B. Each fiber optic connector 90A, 90B includes a housing 94A, 94B having a latch 95A, 95B and a cavity 98A, 98B that contains a ferrule holder 100A, 100B arranged between a spring 99A, 99B and a ferrule 110A, 110B. The ferrules 110A, 110B are shown in a mating relationship, with proximal ends 111A, 111B of the ferrules 110A, 110B in contact with one another. Each connector 90A, 90B is configured to receive an optical fiber (e.g., 10 in FIGS. 4A-4B) bonded to the ferrule 110A, 110B, wherein ends of optical fibers may be terminated flush with the proximal ends 111A, 111B of the ferrules 110A, 110B, so that an optical signal may be transmitted therebetween when the proximal ends 111A, 111B contact one another. Each connector 40A, 40B lacks any crimp band or other feature to promote mechanical coupling with strength members of a fiber optic cable.

In FIG. 10, the springs 99A, 99B are shown as having a first length L_{1A}, L_{1B} that exists when the ferrule holders 100A, 100B have an intermediate length, in which the respective lips 102A, 102B are separated from the medial shoulders 96A, 96B due to slight compression of the springs 99A, 99B upon mating contact of the proximal ends 111A, 111B of the ferrules 110A, 110B. This arrangement helps maintain physical contact between the ferrules 110A, 110B. If a tensile force is applied through optical fibers to the ferrules 110A, 110B, then the springs 99A, 99B may transition from the first length L_{1A}, L_{1B} to a second (compressed) length L_{2A}, L_{2B}. If a spring is compressed to a second length L_{2A}, L_{2B} by which a proximal end 111A, 111B of a ferrule 110A, 110B moves (in a longitudinally inward direction) a distance that exceeds a distance D_{d} (which depends on the existence and size of any gaps between the lips 102A, 102B and the medial shoulders 96A, 96B), then contact may be lost between proximal ends 111A, 111B of the ferrules 110A, 110B and optical signal transmission may be curtailed. Accordingly, the distance D_{d} will be referred to in this disclosure as “decoupling distance D_{d}” or decoupling travel distance D_{d}.”

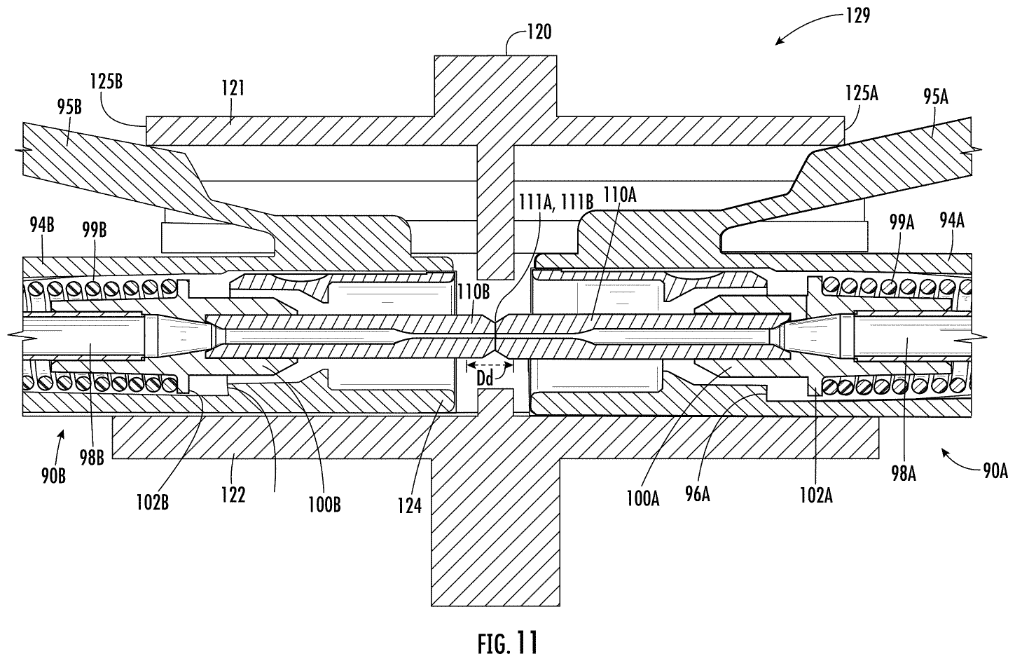

FIG. 11 shows an optical assembly 129 including portions of the two fiber optic connectors 90A, 90B of FIG. 10 received within an adapter 120. The adapter 120 includes walls 121, 122 that bound a cavity 124. The first fiber optic connector 90A may be inserted into a first end 125A of the adapter 120, and the second fiber optic connection 90B may be inserted into a second end 125B of the adapter 120, to guide the fiber optic connectors 90A, 90B into a mating relationship by which proximal ends 111A, 111B of the ferrules 110A, 110B are in contact with one another. The latches 95A, 95B of the fiber optic connectors 90A, 90B may cooperate with engagement features (not shown) of the adapter 120 to retain housings 94A, 94B of the fiber optic connectors 90A, 90B in a fixed position. However, bonding between the ferrules 110A, 110B and optical fibers (e.g., 10 in FIGS. 4A-4B) received therein permits tensile force applied to optical fibers terminated by the fiber optic connectors 90A, 90B to retract the ferrules 100A, 100B in a longitudinally inward direction relative to each fiber optic connector 90A, 90B. The springs 99A, 99B are shown as having a first length L_{1A}, L_{1B} that exists when the ferrule holders 100A, 100B have an intermediate length, in which the respective lips 102A, 102B are separated from the medial shoulders 96A, 96B due to slight compression of the springs 99A, 99B upon mating contact of the proximal ends 111A, 111B of the ferrules 110A, 110B. Each spring 99A, 99B may have a minimum (compressed) length L_{2A}, L_{2B}. If one or both springs 99A, 99B are compressed upon movement of a corresponding ferrule 110A, 110B by a distance that exceeds a decoupling distance D_{d} (which depends on the existence and size of any gaps between the lips 102A, 102B and the medial shoulders 96A, 96B of the respective connectors 90A, 90B), then contact may be lost between proximal ends 111A, 111B of the ferrules 110A, 110B.

To address the problem of potential un-mating of adjacent ferrule ends if a tensile force applied to an optical fiber exceeds a spring force within a connector having a spring-biased ferrule, fiber optic cable assemblies according to embodiments herein include a travel limiting feature in the form of configuring a spring such that a difference between a maximum spring length and a minimum spring length (i.e., when the spring is present within a connector housing) is less than a decoupling distance for travel of a ferrule of the connector. Referring back to FIG. 10, the first connector 90 includes a spring 99A capable of having a first length L_{1A} when the spring 99A is in an elongated state, and is capable of having a second length L_{2A} when the spring 99A is in a compressed state. The first length L_{1A} may correspond to a maximum length of the spring 99A limited by forward travel of the ferrule holder 100A against a structural feature (e.g., medial shoulder 96 shown in FIG. 9) of the housing 94A. The second length L_{2A} may correspond to a minimum length of the spring 99A limited by physical contact of coils of the spring 99A. In certain embodiments, a travel limiting feature of the connector 90A is provided by configuring the spring 99A such that a difference between the maximum spring length and the minimum spring length (e.g., when all coils of the spring 99A are in contact) is less (e.g., 5% less, 10% less, 20% less, 30% less, or another threshold less) than the decoupling distance D_{d} of the first ferrule 110A.

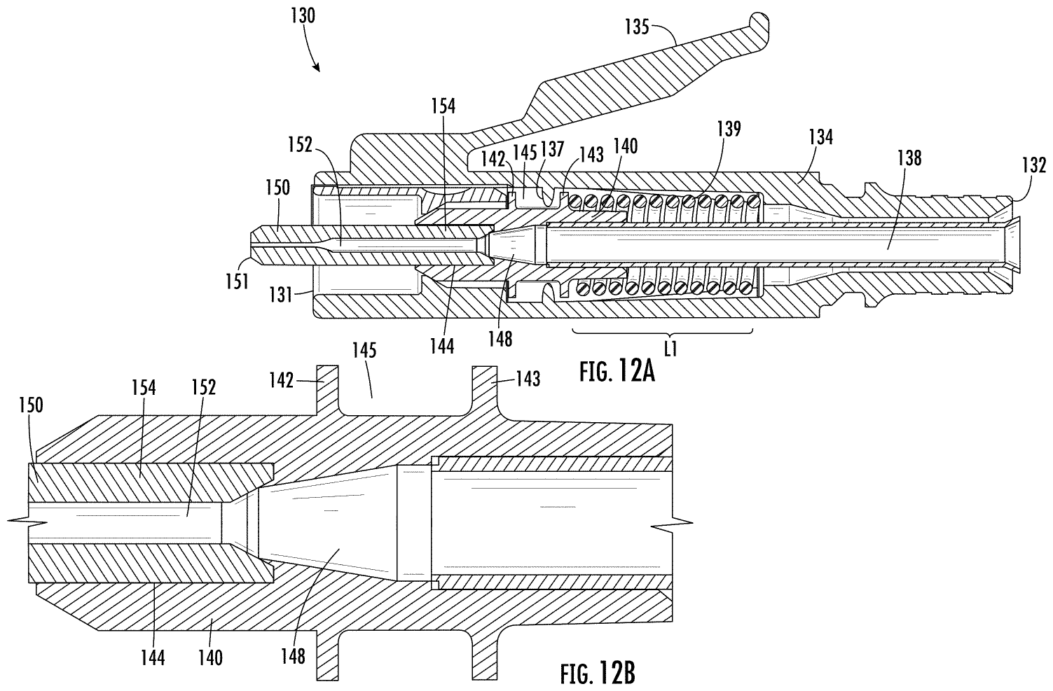

As another method to address the above-identified problem (i.e., potential un-mating of adjacent ferrule ends), a fiber optic cable assembly according to embodiments herein includes a travel limiting feature in the form of cooperative features of a ferrule holder and a housing of a fiber optic connector that serve to limit travel of the ferrule in a longitudinally inward direction. In certain embodiments, a connector housing comprises at least one radially inward protruding feature, and a ferrule holder comprises at least one recess configured to receive the at least one radially inward protruding feature, wherein the at least one recess is bounded by at least one travel stop configured to contact the at least one radially inward protruding feature A travel limiting feature is provided by cooperation between the radially inward protruding feature and the at least one recess, such that contact between the at least one radially inward protruding feature and the at least one travel stop is configured to limit travel of the ferrule in the longitudinally inward direction. One implementation of these items is shown in FIGS. 12A-12B.

FIG. 12A is a side cross-sectional view of a fiber optic connector 130, and FIG. 12B provides a magnified view of a portion of the fiber optic connector 130, configured for terminating a fiber optic cable (e.g., 10 in FIGS. 4A-4B) in a ferrule 150 supported by a spring-biased ferrule holder 140 disposed within a housing 134, with the fiber optic connector 130 being useable in a fiber optic cable assembly according to one or more embodiments devoid of mechanical coupling between tensile strength members and the fiber optic connector 130. The housing 134 which may be unitary or composed of multiple parts, has a proximal end 131, a distal end 132, a depressible latch 134, and a cavity 138 bounded in part by a medial shoulder. The cavity 138 contains the ferrule holder 140, which is positioned between the ferrule 150 and a spring 139, with the spring 139 shown in a position having a first (elongated) length L₁. The ferrule 150 has a substantially cylindrical body and includes a bore 152 configured to receive at least a portion of an optical fiber (e.g., 10 in FIGS. 4A-4B), whereby a tip of the optical fiber may be terminated flush with a proximal end 151 of the ferrule 150, which protrudes forward from the proximal end 131 of the housing 134. The ferrule holder 140 includes a proximal cavity 144 that retains the ferrule 150, a distal cavity 148 that can receive a coated or buffered portion of an optical fiber (e.g. buffer 13 in FIGS. 4A-4B), and includes two radially extending lips 142, 143 that bound a peripheral recess 145. The peripheral recess 145 is configured to receive a radially inward protruding feature 137 of the housing 134. In certain embodiments, multiple radially inward protruding features 137 may be provided along one or more inner surfaces bounding the cavity 138 of the housing 134.

When tension is applied to an optical fiber bonded to the ferrule 150, the ferrule 150 may be retracted in a longitudinal direction toward the distal end 132 of the housing 134, thereby also moving the ferrule holder 140 and compressing the spring 139. However, longitudinally inward (or rearward) travel of the ferrule holder 140 (and the ferrule 150 supported by the ferrule holder 140) will be limited when the radially extending lip 142 contacts the radially inward protruding feature 137 of the housing 134. Size and relative positioning of the radially extending lip 142 of the ferrule holder 140 and the radially inward protruding feature 137 of the housing 134 may be selected to provide a desired travel distance of the ferrule holder 140 and the ferrule 150, wherein such travel distance is desirably selected to be less than a decoupling distance due to travel of the ferrule 150 when tensile force is applied thereto. The fiber optic connector 130 is devoid of mechanical coupling with any tensile strength member optionally present in a fiber optic cable having an optical fiber bonded to the ferrule 150.

Spring constant (“K”) values for standard cylindrical ferrule-based fiber optic connectors (e.g., including but not limited to LC connectors, SC connectors, and the like) are typically around 1500 N/m. A further method to address the above-mentioned problem of potential un-mating of adjacent ferrule ends by application of tensible force to a ferrule by an optical fiber bonded thereto, includes increasing the spring constant of a fiber optic connector spring. In certain embodiments, a spring K-value may be selected to correspond with a critical force just below the expected tensile force that would break the bond between a fiber and ferrule to cause fiber detachment. For example, if an average fiber-to-ferrule adhesion strength is about 34.6 N (7.8 lbf) with a standard deviation of 0.58 lbf, then a spring K-value of about 6000 N/m may be selected, corresponding to a critical tensile force of 5 to 6 lbf at which point a ferrule in mated condition would be un-mated from a corresponding ferrule. The advantage of selecting a value below the maximum adhesion strength is to provide some compliance in case a cable assembly is momentarily loaded with a higher load but that load is not maintained for a long duration. Thus, in certain embodiments, a fiber optic connector utilizing a spring-biased ferrule to which an optical fiber is bonded may incorporate a spring having a K-value of at least about 3000 N/m, at least about 4000 N/m, at least about 5000 N/m, at least about 6000 N/m, or at least about 7000 N/m.

In certain embodiments, a fiber optic cable assembly disclosed herein may include multiple travel limiting features of different types as disclosed herein.

Those skilled in the art will appreciate that other modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents. The claims as set forth below are incorporated into and constitute part of this detailed description.

What is claimed is:

1. A fiber optic cable assembly comprising:
a first cable leg comprising a first optical fiber core, a first cladding surrounding the first optical fiber core, a first coating surrounding the first cladding, and a first tight buffer surrounding and in contact with the first coating;
a second cable leg comprising a second optical fiber core, a second cladding surrounding the second optical fiber core, a second coating surrounding the second cladding, and a second tight buffer surrounding and in contact with the second coating; and
a buffer connecting region connecting the first tight buffer and the second tight buffer, wherein the buffer connecting region comprises a maximum thickness that is less than a maximum outer thickness dimension of the first tight buffer and that is less than a maximum outer thickness dimension of the second tight buffer;
wherein each of the first cable leg and the second cable leg is devoid of a surrounding jacket and is devoid of any tensile strength member.

2. The fiber optic cable assembly of claim 1, wherein the first tight buffer, the second tight buffer, and the buffer connecting region comprise extruded polymeric material.

3. The fiber optic cable assembly of claim 1, wherein the buffer connecting region comprises at least one of a thermally welded interface or a solvent welded interface between the first tight buffer and the second tight buffer.

4. The fiber optic cable assembly of claim 1, wherein the buffer connecting region is configured to be locally torn by manually pulling apart a portion of the first cable leg and a portion of the second cable leg.

5. The fiber optic cable assembly of claim 1, wherein the first tight buffer comprises an outer diameter of no greater than 1.6 mm, and the second tight buffer comprises an outer diameter of no greater than 1.6 mm.

6. The fiber optic cable assembly of claim 1, wherein the first tight buffer comprises an outer diameter of no greater than 1 mm, and the second tight buffer comprises an outer diameter of no greater than 1 mm.

7. The fiber optic cable assembly of claim 1, wherein each of the first cladding and the second cladding comprises a titanium dioxide coating.

8. The fiber optic cable assembly of claim 1, further comprising a first ferrule bonded to the first cladding with heat curable epoxy, and a second ferrule bonded to the second cladding with heat curable epoxy.

9. The fiber optic cable assembly of claim 1, further comprising at least one connector terminating a proximal end of the first cable leg and terminating a proximal end of the second cable leg.

10. The fiber optic cable assembly of claim 9, wherein the at least one connector comprises a first connector terminating the proximal end of the first cable leg and a second connector terminating the proximal end of the second cable leg.

11. The fiber optic cable assembly of claim 1, wherein the maximum thickness of the buffer connecting region is less than 50% of the maximum outer thickness dimension of the first buffer, and is less than 50% of the maximum outer thickness dimension of the second buffer.

12. A fiber optic cable assembly comprising a first optical fiber emanating from a first fiber optic cable, and a fiber optic connector that comprises a first ferrule, a first ferrule holder, a first housing, and a travel limiting feature, wherein:
the first ferrule terminates and is bonded to a portion of the first optical fiber;
the first ferrule holder arranged to support the first ferrule in the first housing, wherein the first ferrule holder is spring-biased and is and configured to press the first ferrule in a longitudinally outward direction relative to a proximal end of the first fiber optic connector; and
the travel limiting feature is configured to limit travel of the first ferrule in a longitudinally inward direction, opposing the longitudinally outward direction, to a distance less than a decoupling travel distance of the first ferrule when the first ferrule is arranged in mating contact with a second ferrule of a second fiber optic connector; and
the first fiber optic connector is devoid of mechanical coupling with any tensile strength member optionally present in the first fiber optic cable.

13. The fiber optic cable assembly of claim 12, wherein:
the first fiber optic connector comprises a spring configured to bias the first ferrule holder;
the spring comprises a maximum spring length and a minimum spring length within the housing, with the minimum spring length corresponding to a fully compressed state of the spring; and
the travel limiting feature is provided by configuring the spring such that a difference between the maximum spring length and the minimum spring length that is less than the decoupling travel distance of the first ferrule.

14. The fiber optic cable assembly of claim 12, wherein:
the housing comprises at least one radially inward protruding feature;
the ferrule holder comprises at least one recess configured to receive the at least one radially inward protruding feature, the at least one recess is bounded by at least one travel stop configured to contact the at least one radially inward protruding feature; and
the travel limiting feature is provided by cooperation between the radially inward protruding feature and the at least one recess, whereby contact between the at least one radially inward protruding feature and the at least one travel stop is configured to limit travel of the ferrule in a longitudinally inward direction that opposes the longitudinally outward direction.

15. The fiber optic cable assembly of claim 12, wherein the first ferrule comprises a substantially cylindrical body defining a first bore that receives a portion of the first optical fiber.

16. The fiber optic cable assembly of claim 12, wherein the first fiber optic cable comprises a first tight buffer surrounding a coating, a cladding, and a core of the first optical fiber at a position outside the first ferrule, and the first fiber optic cable is devoid of any tensile strength member.

17. The fiber optic cable assembly of claim 16, wherein the cladding comprises a titanium dioxide coating.

18. The fiber optic cable assembly of claim 16, wherein the cladding is bonded to the ferrule with heat curable epoxy.

19. A fiber optic cable assembly comprising an optical fiber emanating from a fiber optic cable, and a fiber optic connector that comprises a ferrule, a ferrule holder, and a housing, wherein:
the ferrule terminates and is bonded to a portion of the optical fiber;
the ferrule holder is arranged to support the ferrule in the housing, the ferrule holder being spring-biased and configured to press the ferrule in a longitudinally outward direction relative to a proximal end of the fiber optic connector;
the housing comprises at least one radially inward protruding feature;
the ferrule holder comprises at least one peripheral recess configured to receive the at least one radially inward protruding feature, and the at least one peripheral recess is bounded by at least one travel stop configured to contact the at least one radially inward protruding feature to limit travel of the ferrule in a longitudinally inward direction that opposes the longitudinally outward direction; and
the first fiber optic connector is devoid of mechanical coupling with any tensile strength member optionally present in the first fiber optic cable.

20. The fiber optic cable assembly of claim 19, wherein the ferrule comprises a substantially cylindrical body defining a bore that receives a portion of the optical fiber.

21. The fiber optic cable assembly of claim 19, wherein the fiber optic cable comprises a tight buffer surrounding a coating, a cladding, and a core of the optical fiber at a position outside the ferrule, and the fiber optic cable is devoid of any tensile strength member.

22. The fiber optic cable assembly of claim 21, wherein the cladding comprises a titanium dioxide coating.

23. The fiber optic cable assembly of claim 21, wherein the cladding is bonded to the ferrule with heat curable epoxy.
